(19) United States
(12) Patent Application Publication
(10) Pub. No.: US 2020/0259879 A1
(43) Pub. Date: Aug. 13, 2020

(54) INTERACTION METHOD AND DEVICE FOR MOBILE TERMINAL AND CLOUD PLATFORM OF UNMANNED AERIAL VEHICLE

(71) Applicant: SZ DJI TECHNOLOGY CO., LTD., Shenzhen (CN)

(72) Inventors: Chuantang XIONG, Shenzhen (CN); Liming FAN, Shenzhen (CN); Zhiqiang WU, Shenzhen (CN)

(21) Appl. No.: 16/864,956

(22) Filed: May 1, 2020

Related U.S. Application Data
(63) Continuation of application No. PCT/CN2017/109558, filed on Nov. 6, 2017.

(51) Int. Cl. H04L 29/06; H04W 84/18; B64C 39/02

(52) U.S. Cl. CPC H04L 65/605; H04L 65/608; B64C 2201/12; H04W 84/18; B64C 39/024; H04L 65/4092

(57) ABSTRACT

An interaction method includes obtaining a livestreaming confirmation from a server, obtaining a livestreaming address corresponding to the UAV from the server, and playing a real time video stream according to the livestreaming address. The livestreaming confirmation indicates that the UAV is in a livestreaming status. The real time video stream is uploaded to the server by a mobile terminal associated with the UAV.

### CROSS-REFERENCE TO RELATED APPLICATION

This application is a continuation of International Application No. PCT/CN2017/109558, filed Nov. 6, 2017, the entire content of which is incorporated herein by reference.

### TECHNICAL FIELD

The present disclosure relates to unmanned aerial vehicle field and, more particularly, to a method and device for the interaction between a mobile terminal and a cloud platform of an unmanned aerial vehicle (UAV).

### BACKGROUND

With the maturity of the technology in unmanned aerial vehicle (UAV), unmanned aerial vehicles are implemented into industry-level applications and bring significant efficiency advancement to industry-level customers. Unmanned aerial vehicles (UAVs) play a pivotal role especially in power inspection, security patrol, pipeline inspection, modeling and mapping, and agricultural planting, etc. For the industry-level customers, they have a large quantity of groups with multiple members in each group, and each member manages one or more unmanned aerial vehicles (UAVs) for applications in different working ranges.

Currently, the industry-level customers can obtain images from unmanned aerial vehicles (UAVs) through domestic or foreign cloud technology service providers, which cannot satisfy real time monitoring UAVs' requirements of the industry-level customers.

### SUMMARY

In accordance with the disclosure, there is provided an interaction method including obtaining a livestreaming confirmation from a server, obtaining a livestreaming address corresponding to the UAV from the server, and playing a real time video stream according to the livestreaming address. The livestreaming confirmation indicates that the UAV is in a livestreaming status. The real time video stream is uploaded to the server by a mobile terminal associated with the UAV.

Also in accordance with the disclosure, there is provided an interaction device including one or more processors individually or collectively configured to obtain a livestreaming confirmation from a server, obtain a livestreaming address corresponding to the UAV from the server, and play a real time video stream according to the livestreaming address. The livestreaming confirmation indicates that the UAV is in a livestreaming status. The real time video stream is uploaded to the server by a mobile terminal associated with the UAV.

Also in accordance with the disclosure, there is provided an interaction method implemented by a server. The method includes receiving a livestreaming request from the cloud platform, and returning a response to the cloud platform in response to the livestreaming requesting. The livestreaming request carries an address code associated with an unmanned aerial vehicle (UAV) to which a to-be-played live video stream belongs. The response triggers the cloud platform to obtain a livestreaming address corresponding to the UAV according to the response and the address code, and to play a real time video stream according to the livestreaming address. The real time video stream is uploaded by a mobile terminal associated with the UAV to the server.

Based on the technical solution embodiments of the present disclosure, the mobile terminal associated with the UAV of the present disclosure can push the real time video stream of the UAV to the server after obtaining the livestreaming address from the server. The cloud platform, after obtaining the livestreaming address of the UAV from the server, can pull (display). As such, real time sharing of the video stream of the UAV is realized, and the needs to remotely monitor the UAV is satisfied. It is suitable for the industry-level users to monitor a large quantity of UAVs.

### BRIEF DESCRIPTION OF THE DRAWINGS

FIG. 1 is a network diagram of an interaction system of a mobile terminal associated with an unmanned aerial vehicle (UAV) and a cloud platform according to an example embodiment of the disclosure.

FIG. 2 is a flow chart of a method for an interaction between a mobile terminal associated with a UAV and a cloud platform at the platform side according to an example embodiment of the disclosure.

FIG. 3 is a schematic diagram of a partial display interface of a cloud platform according to an example embodiment of the disclosure.

FIG. 4 is a flow chart of a method for an interaction between a mobile terminal associated with a UAV and a cloud platform at the server side according to an example embodiment of the disclosure.

FIG. 5 is a flow chart of a method for an interaction between a mobile terminal associated with a UAV and a cloud platform at the terminal side according to an example embodiment of the disclosure.

FIG. 6 is a flow chart of a method for an interaction between a mobile terminal associated with a UAV and a cloud platform at the server side according to another example embodiment of the disclosure.

FIG. 7 is a schematic structural diagram of a device for an interaction between a mobile terminal associated with a UAV and a cloud platform at the platform side according to an example embodiment of the disclosure.

FIG. 8 is a schematic structural diagram of a device for an interaction between a mobile terminal associated with a UAV and a cloud platform at the terminal side according to an example embodiment of the disclosure.

FIG. 9 is a schematic structural diagram of a device for an interaction between a mobile terminal associated with a UAV and a cloud platform at the server side according to an example embodiment of the disclosure, indicating a relationship between a server and a cloud platform.

FIG. 10 is a schematic structural diagram of a device for an interaction between a mobile terminal associated with a UAV and a cloud platform at the server side according to an example embodiment of the disclosure, indicating a relationship between a server and a mobile terminal.

FIG. 11 is a schematic structural diagram of an interaction system between a mobile terminal associated with a UAV and cloud platform according to an example embodiment of the disclosure.

### DETAILED DESCRIPTION OF THE EMBODIMENTS

Technical solutions of the present disclosure will be described with reference to the drawings. The following described embodiments are only some of the embodiments not all the embodiments of the present disclosure. All other embodiments obtained by those of ordinary skill in the art based on these embodiments of the present disclosure without creative efforts are within the scope of the present disclosure.

Detailed descriptions are provided for an interaction method and device for a mobile terminal associated with a UAV and a cloud platform with reference drawings. In case of no conflict the features of the following embodiments and methods can be combined with each other.

FIG. 1 is a network diagram of an interaction system of a mobile terminal associated with an unmanned aerial vehicle (UAV) and a cloud platform according to an example embodiment of the disclosure, and FIG. 11 is a schematic structural diagram of an interaction system of a mobile terminal associated with a UAV and a cloud platform according to an example embodiment of the disclosure. As shown in FIG. 1 and FIG. 11, the interaction system of the mobile terminal associated with the UAV and the cloud platform includes a cloud platform 100 (web end in FIG. 1), a server 200 (back end in FIG. 1), a UAV, and a UAV controlling mobile terminal 300 (APP end in FIG. 1). The cloud platform 100 and the UAV controlling mobile terminal 300 are connected to and communicate with each other via the server 200. The mobile terminal 300 can control the operation of the corresponding UAV and collect data from the corresponding devices.

The UAV controlling mobile terminal 300 can include one or more of a remote controller, a smart phone, a tablet, a laptop, and a wearable device (watch, wristband, etc.). The mobile terminal 300 of the present embodiment can have an APP (i.e., application software) installed thereon.

The cloud platform 100 can include one or more of a desktop, a smart phone, a tablet, a laptop, etc. Additionally, users can operate the cloud platform 100 by logging on the webpage on web (World Wide Web) to implement data transmission between the cloud platform 100 and the server 200.

The communicative connections between the cloud platform 100 and the server 200 as well as between the mobile terminal 300 and the server 200 can be realized based on wireless or wired means. In some embodiments, wireless communicative connections are used between the client end and the server 200 as well as between the mobile terminal 300 and the server 200.

In the present embodiment, there can be more than one UAV, and multiple UAVs can push stream (upload) to the server 200 synchronously or asynchronously according to the livestreaming addresses obtained individually from the server 200, and the cloud platform 100 can obtain livestreaming addresses of one or more UAVs required for playing from the server 200 and pull (display) according to the obtained livestreaming addresses of the UAVs, so as to implement monitoring one or more UAVs remotely to improve the efficiency of the UAV monitoring.

In some embodiments of the present disclosure, video stream can include both video data and audio data or only video data.

Example interaction methods for a mobile terminal associated with a UAV and a cloud platform will be described below from the cloud platform 100 side, the server 200 side, and the mobile terminal 300 side, respectively.

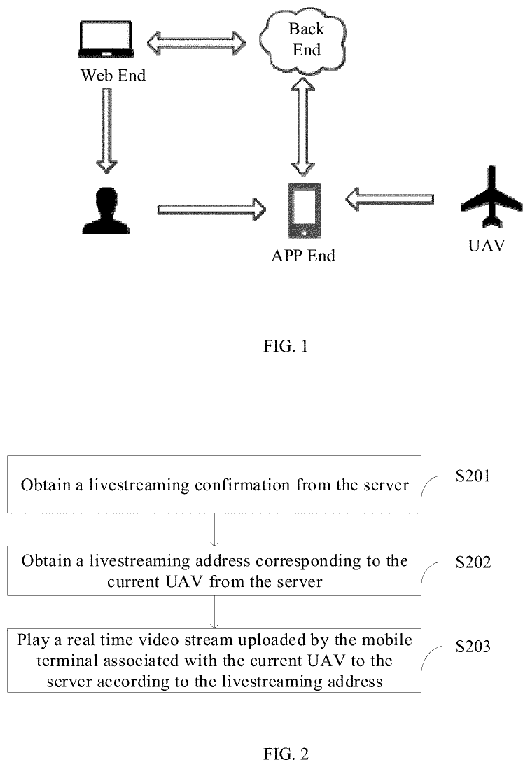

FIG. 2 is a flow chart of a method for an interaction between a mobile terminal associated with a UAV and a cloud platform according to an example embodiment of the disclosure. The method can be implemented in, e.g., the cloud platform 100.

As shown in FIG. 2, at S201, a livestreaming confirmation is obtained from the sever 200. The livestreaming confirmation indicates that a current UAV is in a livestreaming status.

In some embodiments, obtaining the livestreaming confirmation by the cloud platform 100 from the sever 200 includes determining that a livestreaming request sent by the mobile terminal 300 associated with the current UAV is received and successfully accepted by the sever 200. The cloud platform 100 monitors in real time data information (e.g., status information, livestreaming request, livestreaming confirmation, etc., but not including video streams) sent by the mobile terminal 300 associated with the current UAV and received by the sever 200. In one embodiment, the cloud platform 100 detects that the server 200 receives the livestreaming confirmation sent by the mobile terminal 300 associated with the current UAV after receiving the livestreaming request sent by the mobile terminal 300 associated with the current UAV. At this moment, the cloud platform 100 confirms the livestreaming request sent by the mobile terminal 300 associated with the current UAV was successful. In another embodiment, if, within a preset time (e.g., 10s) after the sever 200 receives the livestreaming request sent from the mobile terminal 300 associated with the current UAV, the sever 200 receives the real time video stream sent by the mobile terminal 300 associated with the current UAV, then the server 200 generates the livestreaming confirmation. After the cloud platform 100 detects the livestreaming confirmation generated by the sever 200, the cloud platform 100 can confirm that the livestreaming request sent by the mobile terminal 300 associated with the current UAV was successful.

At S202, a livestreaming address corresponding to the current UAV is obtained from the sever 200.

In some embodiments, the cloud platform 100 sends a streaming request to the sever 200. When the cloud platform 100 receives a first response returned by the server 200 according to the streaming request, the cloud platform 100 can obtain the livestreaming address corresponding to the current UAV according to the first response. As such, the cloud platform 100 can pull the stream according to the obtained livestreaming address and monitor the operation of the current UAV. Obtaining the livestreaming address through streaming request improves the security of the video data of the UAV and prevents the video data of the UAV from being illegally stolen.

In some embodiments, the streaming request carries a first address code of the UAV to which a to-be-played live video stream belongs and the first address code can be used to indicate UAV information (for example, the UAV information can include a terminal identification of the mobile terminal 300 that controls the UAV, a UAV identification, etc.) of the UAV to which the to-be-played live video stream belongs. Taking the UAV identification as an example of the UAV information, if the UAV is in the livestreaming status, the sever 200 will cache the live video stream of the current UAV to a specified area according to the UAV identification. When receiving the first address code, the sever 200 can find the live video stream (i.e., the to-be-played live video stream requested by the current streaming request) corresponding to the UAV identification according to the first address code, and find a second address code of the UAV to which the to-be-played live video stream belongs. The first address code can be pre-stored in the current cloud platform 100. Obtaining the livestreaming address corresponding to the current UAV by the cloud platform 100 according to the first response further includes obtaining the livestreaming address corresponding to the current UAV according to the first response and the first address code. Specifically, the cloud platform 100 can obtain the livestreaming address corresponding to the current UAV according to the first response and the first address code if the cloud platform 100 determines that the first response satisfies a first specific condition. In some embodiments, the cloud platform 100 determining that the first response satisfies the first specific condition includes determining that the first response contains the second address code of the UAV to which the to-be-played live video stream belongs. The cloud platform 100 generates the livestreaming address of the UAV to which the to-be-played live video stream belongs according to the first address code and the second address code when the cloud platform 100 determines that the first response contains the second address code. In this embodiment, by performing authentication and encryption on the livestreaming address, the cloud platform 100 can obtain the livestreaming address of the current UAV only if the cloud platform 100 has both the first address code and the second address code, so that the security of the video data of the UAV is ensured. In one embodiment, the livestreaming address is divided into two parts, including the first address code and the second address code. The cloud platform 100 generating the livestreaming address of the UAV to which the to-be-played live video streams belongs according to the first address code and the second address code includes generating the livestreaming address by combining the first address code and the second address code. For example, the livestreaming address is the first address code A+the second address code B, and after the cloud platform 100 obtains the first address code A and the second address code B, the cloud platform 100 combines the two address codes to generate the complete livestreaming address. In another embodiment, the livestreaming address is divided into two parts. The first part can be obtained by the cloud platform 100 through calculation based on a first pre-set algorithm, and the second part can be obtained by the cloud platform 100 through calculation based on a second pre-set algorithm. After the cloud platform 100 obtains the first part and the second part, the cloud platform 100 combines the first part and the second part to obtain the complete livestreaming address. By this method, the difficulty in illegally stealing the livestreaming address is further increased. The first pre-set algorithm and the second pre-set algorithm can be identical or different.

Further, the cloud platform 100 determining that the first response satisfies the first specific condition also includes determining that a time from the server 200 sent the second address code to a current time (i.e., a time since the server 200 sent the second address code) is shorter than or equal to a first time threshold. As such, even if the first address code and the second address code are illegally stolen by illegal users, the interference with legitimate users will be temporary because the second address code is effective for only a given period of time. The security of the livestreaming of the UAV is improved significantly by setting the second address code to be effective for the given period of time. For example, the first pre-set time threshold can be set to 10 min, and hence the illegal users who illegally stole the livestreaming address can only watch the video stream for 10 min. After 10 min, the sever 200 will generate a new second address code and send the new second address code to the cloud platform 100 of the legitimate users who send the streaming request. As such, the difficulty of illegally stealing the complete livestreaming address is increased, and the security of the livestreaming of the UAV is improved. After determining that the first response contains the second address code of the UAV to which the to-be-played live video stream belongs, if the cloud platform 100 determines that the time since the server 200 sent the second address code is longer than the first time threshold, the cloud platform 100 will not obtain the livestreaming address corresponding to the current UAV according to the first response and the first address code. The time since the sever 200 sent the second address code being longer than the first time threshold indicates that the second address code is invalid, and hence the livestreaming address obtained according to the first address code and the second address code is also invalid. When the cloud platform 100 determines that the time since the server 200 sent the second address code is longer than the first time threshold, the cloud platform 100 generates a first prompt message. The first prompt message indicates that the current streaming request fails. The first prompt message can be displayed as a dialog window on the cloud platform 100, or can be displayed in another form.

In some embodiments, after the cloud platform 100 sends the streaming request to the sever 200, the cloud platform 100 may receive the first prompt message indicating the failure of the current streaming request returned by the sever 200. In some embodiments, the streaming request contains a user identification. After the sever 200 receives the streaming request, the server 200 may verify the legitimacy of the user. If the sever 200 determines that the user identification of the current streaming request is a legitimate identification, the server 200 determines that the user sending the streaming request is a legitimate user and sends the first response carrying the second address code to the cloud platform 100. If the sever 200 determines that the user identification of the current streaming request is an illegal user identification, the server 200 determines that the user sending the streaming request is an illegal user, and sends the first prompt message to the cloud platform 100 to indicate the failure of the streaming request.

At S203, a real time video stream uploaded by the mobile terminal 300 associated with the current UAV to the sever 200 is played according to the livestreaming address.

In some embodiments, the cloud platform 100 plays the real time video uploaded by the mobile terminal 300 associated with the current UAV to the sever 200 using a player, such as a flash player or a player of another type. As such, real time sharing of the UAV video data can be realized for conveniently managing the operation of the UAV remotely. If the real time video uploaded by the mobile terminal 300 associated with the current UAV to the sever 200 gets stuck during playing, it can be solved according to an existing method.

In some embodiments of the present disclosure, the cloud platform 100 can pull stream (display) after the livestreaming address of the UAV is obtained from the sever 200. This realizes real time sharing of the video stream of the UAV, satisfying the needs of conveniently monitoring the UAV remotely, which is especially suitable for the industry-level users to monitor a relatively large number of UAVs.

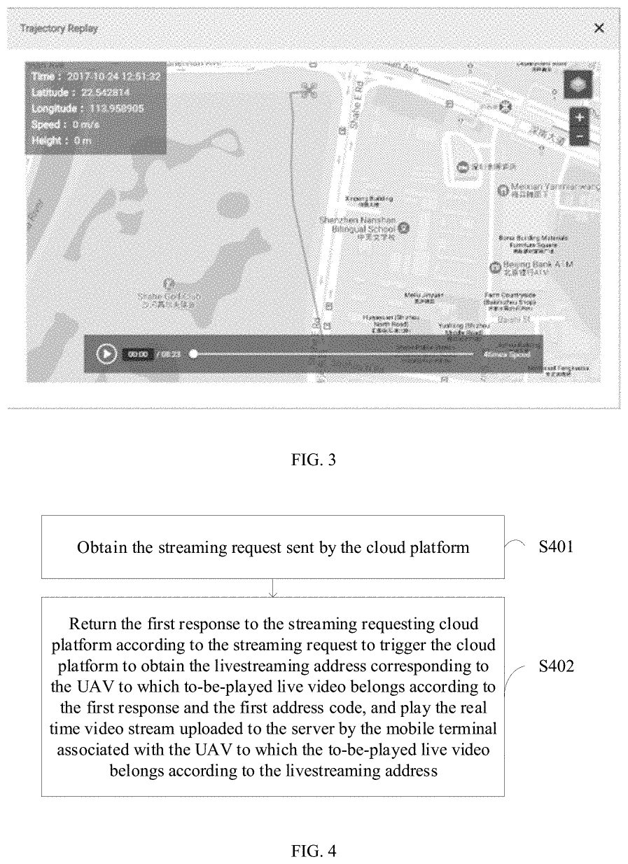

In some embodiments, the method can further include monitoring the data sent by the mobile terminal 300 associated with the current UAV to the sever 200 to obtain the real time status of the current UAV in a timely manner. The data information can include status information, livestreaming request, livestreaming confirmation, etc., but does not include video stream. In some embodiments, the data information includes the status information of the current UAV. While monitoring the data sent by the mobile terminal 300 associated with the current UAV to the sever 200, the cloud platform 100 also records the status information of the current UAV, such that the status information of the current UAV can be searched for and played back at a later time. Further, the status information can include GPS data (including latitude and longitude) of the current UAV. While recording the status information of the current UAV, the cloud platform 100 can also generate a flight trajectory of the current UAV according to the recorded GPS data. The cloud platform 100 can also play back the generated flight trajectory so that the historical flight trajectory of the UAV can be reviewed. In some embodiments, the status information can further include flight height and/or flight speed of the current UAV. The cloud platform 100 replaying the generated flight trajectory includes dynamically playing back the flight trajectory according to the flight speed and/or flight height to realize the visualization and dynamical display of the flight trajectory of the UAV, so that the displayed flight trajectory is more intuitive. In some embodiments, the cloud platform 100 can dynamically play back the flight trajectory using map components and animation components. It would be appreciated that the map components may include any suitable map components and the animation components may include any suitable animation components, without departing from the scope of the disclosure. In addition, the cloud platform 100 can display the status information of the UAV corresponding to the current displaying flight status simultaneously when the cloud platform 100 dynamically plays back the flight trajectory. FIG. 3 is a schematic diagram of a portion of a display interface of the cloud platform 100 according to an example embodiment of the disclosure. As shown in FIG. 3, the flight trajectory of the current UAV is dynamically displayed using the map components, and the current time and the longitude/latitude, the flight speed, and the flight height in the flight status of the UAV at the current time are also displayed. In some embodiments, the status information also includes other data information during the flight of the current UAV.

FIG. 4 is a flow chart of a method for an interaction between a mobile terminal associated with a UAV and a cloud platform at the server side according to an example embodiment of the disclosure. The method can be implemented in, e.g., the server 200, and the interaction can be between, e.g., the server 200 and the mobile terminal 300.

As shown in FIG. 4, at S401, the streaming request sent by the cloud platform 100 is received. The streaming request carries the first address code of the UAV to which the to-be-played live video stream belongs.

In some embodiments, the cloud platform 100 monitors the data (e.g., status information, livestreaming request, livestreaming confirmation, etc., not including video stream) sent by the mobile terminal 300 associated with the current UAV received by the sever 200. The cloud platform 100 only sends streaming request to the server 200 when the cloud platform 100 detects that the livestreaming confirmation is obtained by the server 200, so as to ensure that the mobile terminal 300 associated with the current UAV has requested the livestreaming (i.e., the current UAV is in livestreaming status) and the request was successful. The livestreaming confirmation is used to indicate the livestreaming status of the current UAV. In one embodiment, the cloud platform 100 detects that the server 200 receives both the livestreaming request sent by the mobile terminal 300 associated with the current UAV and the livestreaming confirmation sent by the mobile terminal 300 associated with the current UAV, and at this moment, the cloud platform 100 can confirm that the mobile terminal 300 associated with the current UAV sent the successful livestreaming request. Before the server 200 receives the streaming request sent by the cloud platform 100, the process also includes receiving the livestreaming confirmation sent by the mobile terminal 300 associated with the current UAV.

In another embodiment, in a pre-set time (e.g., 10s) after the server 200 receives the livestreaming request sent by the mobile terminal 300 associated with the current UAV, the server 200 also receives the real time video stream sent by the mobile terminal 300 associated with the current UAV, and the server 200 itself generates the livestreaming confirmation. After the cloud platform 100 detects the livestreaming confirmation generated by the server 200, it confirms that the livestreaming request sent by the mobile terminal 300 associated with the current UAV is successful. Before the server 200 receives the streaming request sent by the cloud platform 100, the process also includes generating livestreaming confirmation when receiving the real time video stream of the UAV to which the to-be-played live video belongs uploaded by the mobile terminal 300 according to the livestreaming address.

At S402, the first response is returned to the streaming requesting cloud platform 100 (i.e., the cloud platform 100 that sent the streaming request) according to the streaming request to trigger the cloud platform 100 to obtain the livestreaming address corresponding to the UAV to which to-be-played live video belongs according to the first response and the first address code, and play the real time video stream uploaded to the server 200 by the mobile terminal 300 associated with the UAV to which the to-be-played live video belongs according to the livestreaming address.

In some embodiments of the present disclosure, the cloud platform 100 can pull (display) after obtaining the livestreaming address of the UAV from server 200, and implement the real time sharing of the UAV video stream to satisfy the needs of conveniently monitoring the UAV remotely. Especially, these features are suitable for the industry-level users for monitoring a large quantity of UAVs.

In some embodiments, returning by the server 200 the first response to the streaming requesting cloud platform 100 according to the streaming request (S402) includes searching for the to-be-played live video stream according to the first address code, obtaining the second address code of the UAV to which the to-be-played live video stream belongs, and returning the first response containing the second address code of the UAV to which the to-be-played live video stream belongs to the cloud platform 100, to enable the cloud platform 100 to pull through the obtained livestreaming address, so as to monitor the operation of the current UAV. The cloud platform 100 of the embodiment obtains livestreaming address through the streaming request, so that the security of the UAV video data is high, and the possibility of the UAV video data being stolen is low. The first address code can be used to indicate the UAV information (e.g., the UAV information can be the terminal identification of the mobile terminal 300 that controls the UAV, the UAV identification, etc.) of the UAV to which the to-be-played live video stream belongs. Taking the UAV identification as an example of the UAV information for further explanation, if the current UAV is in livestreaming status, the server 200 will cache the live video stream of the current UAV to the specified area according to the UAV identification. After the server 200 receives the first address code, the server 200 can search the corresponding live video stream (i.e., the to-be-played live video stream of the current streaming request) according to the UAV identification indicated by the first address code and obtain the second address code of the UAV to which the to-be-played live video stream belongs. The first address code can be pre-stored in the cloud platform 100.

In addition, the streaming request also contains the user identification. The server 200 verifies the user legitimacy after the server 200 receives the streaming request. The server 200 determines the user that is currently sending the streaming request as a legitimate user when the server 200 determines the user identification carried by the current streaming request is a legitimate user identification, and then the server 200 sends the first response carrying the second address code to the cloud platform 100. The server 200 determines the user that is currently sending the streaming request as an illegal user when the server 200 determines the user identification carried by the current streaming request is an illegal user identification, and then the server 200 sends the first prompt message to the cloud platform 100 to indicate the failure of the current streaming request. In some embodiments, the operation that the server 200 returns the first response carrying the second address code of the UAV, to which the to-be-played live video stream belongs, to the cloud platform 100, is executed when the server 200 determines the user identification as a legitimate user identification, so that the illegal stealing of the livestreaming address is prevented and the security of the UAV live video data is assured.

In addition, the first response also carries the first time threshold. The first time threshold indicates that the second address code is valid when the time since the server 200 sent the second address code is less than or equal to the first time threshold, and the second address code is invalid when the time since the server 200 sent the second address code is longer than the first time threshold. As such, even both the first address code and the second address code are stolen by illegal users, but because the second address code is effective for only a given period of time, the illegal users can only cause temporary interference to the legitimate users. By setting the second address code being effective for a given period of time, the security of the UAV is improved significantly. For example, the first preset time threshold can be set to 10 minutes, and the illegal user can only watch the video stream for 10 minutes by illegally obtaining the livestreaming address. After 10 minutes, the server 200 will generate a new second address code and send the new second address code to the cloud platform 100 where the legitimate users who sent the livestreaming request are. The method consistent with the disclosure increases the difficulty to illegally obtain the complete livestreaming address and improves the security of the UAV livestreaming. When the time since the server 200 sent the second address is longer than the first time threshold, the second address code is invalid, so that the livestreaming address obtained according to the first address code and the second address code is invalid. When the server 200 determines the user identification is illegal after it obtains the second address code of the UAV to which the to-be-played live video stream belongs, the sever 200 cancels the execution of the operation to return to the cloud platform 100 the first response containing the second address code of the UAV to which the to-be-played live video stream belongs, to prevent the illegal use of the livestreaming address of the current UAV. The server 200 of the embodiment returns the first prompt message indicating the failure of the streaming request to streaming requesting the cloud platform 100 after it determines the user identification is an illegal user identification, so as to prompt the user of the failure of the livestreaming request.

In addition, in some embodiments, the method further includes receiving the data of the current UAV sent by the mobile terminal 300 associated with the current UAV, and sending the received data to the cloud platform 100, so that the user can know the real time status of the current UAV. The data can include status information, livestreaming request, livestreaming confirmation, etc., but does not include video stream. In some embodiments, the data includes the status information of the current UAV. Further, the status information includes GPS data (including latitude and longitude) of the current UAV. Furthermore, the status information can also include the flight height and/or flight speed of the current UAV. In some embodiments, the status information can also include other data during the flight of the current UAV.

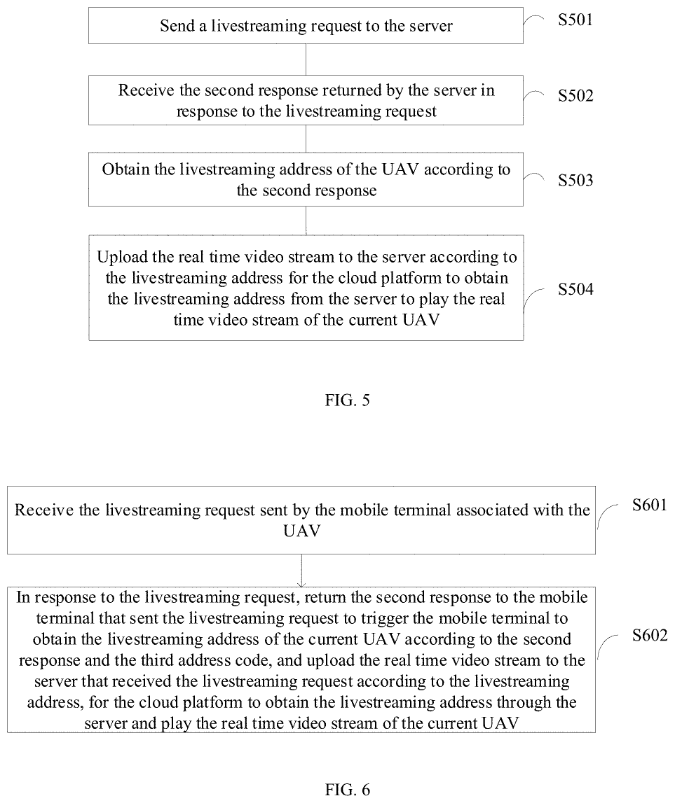

FIG. 5 is a flow chart of a method for an interaction between a mobile terminal associated with a UAV and a cloud platform at the mobile terminal side according to an example embodiment of the disclosure. The main body to execute the interaction method between the mobile terminal associated with the UAV and the cloud platform is the UAV controlling mobile terminal 300.

As shown in FIG. 5, at S501, a livestreaming request is sent to the server 200.

The livestreaming request is used to indicate that the current UAV is the livestreaming requesting UAV. The livestreaming request carries the third address code of the UAV (i.e., livestreaming requesting UAV) to which the to-be-played live video stream belongs, and the third address code can be used to indicate the UAV information (e.g., the UAV identification etc.) of the livestreaming requesting UAV. Taking the UAV identification as an example of the UAV information for further explanation, after the sever 200 receives the third address code sent by the mobile terminal 300 for controlling the current livestreaming requesting UAV, the server 200 can search to see if there is storage space for storing the to-be-played live video stream according to the UAV identification indicated by the third address code. If the located storage space is enough (larger than or equal to the preset storage space), the current livestreaming request is successful. The server 200 will generate the fourth address code of the UAV to which the to-be-played live video stream belongs according to the located storage space. If the located storage space is not enough (smaller than the preset storage space), the livestreaming request is unsuccessful, and the server 200 returns the second prompt message indicating the failure of the livestreaming request to the corresponding mobile terminal 300. The third address code can be pre-stored in the mobile terminal 300 for controlling the livestreaming requesting UAV.

In addition, the livestreaming request carries the terminal identification of the mobile terminal 300 associated with the UAV that is currently sending the livestreaming request. After the server 200 receives the livestreaming request, the legitimacy of the mobile terminal 300 is verified. When the server 200 determines the terminal identification carried by the current livestreaming request is a legitimate identification, the server 200 determines that the mobile terminal 300 sending the livestreaming request is a legitimate terminal, and the current livestreaming request is successful, then the server 200 sends the second response carrying the fourth address code to the mobile terminal 300. When the server 200 determines the terminal identification carried by the current livestreaming request is an illegal terminal identification, the server 200 determines the mobile terminal 300 sending the current livestreaming is an illegal terminal, and the current livestreaming request is unsuccessful, then the server 200 sends the second prompt message to the corresponding mobile terminal to indicate the failure of the current livestreaming request. When the server 200 determines the mobile terminal 300 sending the current livestreaming request is an illegal terminal, the server 200 returns the second prompt message rather than the second response to improve the security of the UAV livestreaming.

After the mobile terminal 300 executes the process at S501, if the request fails, the mobile terminal 300 will receive the second prompt message indicating the failure of the current livestreaming request returned by the server 200 according to the livestreaming request. The second prompt message can be displayed as a dialog on the cloud platform 100. In some embodiments, the second prompt message can be displayed on the cloud platform 100 in other forms. If the livestreaming request is successful, the operation at S502 is executed.

At S502, the second response returned by the server 200 in response to the livestreaming request is received.

In some embodiments, the second response is returned by the server 200 according to the third address code. In some other embodiments, the second response is returned by the server 200 according to the third address code and the terminal identification, and the livestreaming security of the UAV is improved.

At S503, the livestreaming address of the UAV is obtained according to the second response.

In some embodiments, S503 includes obtaining the livestreaming address of the current UAV according to the second response and the third address code. Specifically, obtaining the livestreaming address of the current UAV by the mobile terminal 300 according to the second response and the third address code is executed when the second response is determined to satisfy the second specific condition. In some embodiments, the mobile terminal 300 determining the second response satisfies the second specific condition including determining that the second response contains the fourth address code of the UAV to which the to-be-played live video streams belongs. When the mobile terminal 300 determines that the second response contains the fourth address code of the UAV to which the to-be-played live video stream belongs, the mobile terminal 300 generates the livestreaming address of the UAV to which the to-be-played live video stream belongs according to the third address code and the fourth address code. By authenticating and encrypting the livestreaming address in some embodiments, the mobile terminal 300 can only obtain the livestreaming address of the current UAV when it obtains both of the third address code and the fourth address code, so that the security of the UAV video data is ensured. In one embodiment, the livestreaming address is divided into two parts, including the third address code and the fourth address code. The mobile terminal 300 generates the livestreaming address of the UAV to which the to-be-played live video stream belongs according to the third address code and the fourth address code. The process includes combining the third address code and the fourth address code to generate the livestreaming address. For example, the livestreaming address is the third address code C+the fourth address code D, and the mobile terminal 300 combines the obtained third address code C and the obtained fourth address code D to obtain the complete livestreaming address. In another embodiment, the livestreaming address is divided into two parts, the first part can be obtained by the mobile terminal 300 through calculation according to the third preset algorithm, and the second part can be obtained by the mobile terminal 300 through calculation according to the fourth preset algorithm. The cloud platform 100 combines the first and second parts to obtain the complete livestreaming address after obtaining the first and second parts. By using this method, the difficulty of illegal stealing of the livestreaming address is increased. The third preset algorithm and the fourth preset algorithm can be identical or different. In the present embodiment, the livestreaming address generated by the mobile terminal 300 according to the third address code C and the fourth address code D and the livestreaming address generated by the cloud platform 100 according to the first address code A and the second address code B in the embodiment above are the same addresses, i.e., the livestreaming address of the present embodiment and the livestreaming address of the embodiment above are the same addresses. In some embodiments, the third address code C can be same as the one of the first address code A and the second address code B, and the fourth address code D can be same as the other one of the first address code A and the second address code B. In some embodiments, the third address code C can be different from both the first address code A and the second address code B, and the fourth address code D can be different from both the first address code A and the second address code B.

In addition, the mobile terminal 300 determining that the second response satisfies the second specific condition includes determining that the time since the server 200 sent the fourth address code is shorter than or equal to a second time threshold. In this way, even if the third address code and the fourth address code are illegally obtained by the illegal mobile terminal 300 at the same time such that the current mobile terminal 300 cannot upload the video of the livestreaming requesting UAV to the server 200, because the fourth address code is effective for only a given period of time, the illegal mobile terminal 300 can only temporarily interfere with the current mobile terminal 300. The security of the UAV livestreaming is significantly improved by setting the fourth address code to be effective for only a given period of time. For example, the second time threshold can be set to 10 minutes, and the illegal mobile terminal 300 illegally obtaining the livestreaming address can interfere for at maximum 10 minutes. After 10 minutes, the server 200 will generate a new fourth address code, and send the new fourth address code to the livestreaming requesting mobile terminal 300. As such, the difficulty to illegally obtain the complete livestreaming address is increased so that the security of the UAV livestreaming is improved. After the mobile terminal 300 determines that the second response contains the fourth address code of the UAV to which the to-be-played live video stream belongs, if the mobile terminal 300 also determines that the time since the server 200 sent the fourth address code is longer than the second time threshold, the mobile terminal 300 cancels the execution of the operation to obtain the livestreaming address of the current UAV according to the second response and the third address code. The time since the server 200 sent the fourth address code being longer than the second time threshold indicates that the second address code is invalid, and hence the livestreaming address obtained through the third address code and the fourth address code is also invalid. After the mobile terminal 300 determines the time since the server 200 sent the fourth address code is longer than the second time threshold, the mobile terminal 300 also generates the second prompt message indicating the failure of the current livestreaming request. The second prompt message can be displayed in a dialog window on the current livestreaming requesting mobile terminal 300. In some embodiments, the second prompt message can also be displayed in other forms on the current livestreaming requesting mobile terminal 300.

In some embodiments, after the mobile terminal 300 generates the livestreaming address of the UAV to which the to-be-played live video stream belongs, the mobile terminal 300 also sends the livestreaming confirmation to the server 200, and the livestreaming confirmation is used to indicate that the current UAV is in the livestreaming status, so that the cloud platform 100 can obtain the video stream of the current UAV in time after the livestreaming confirmation is obtained.

At S504, the real time video stream is uploaded to the server 200 according to the livestreaming address for the cloud platform 100 to obtain the livestreaming address from the server 200 to play the real time video stream of the current UAV.

In some embodiments, after the mobile terminal 300 obtains the livestreaming address from the server 200, the mobile terminal 300 can send the UAV real time video stream to the server 200, and, after the livestreaming address is obtained, the cloud platform 100 can pull (display) to realize the real time sharing of the UAV video stream, which is convenient for monitoring the UAV remotely. These features are especially suitable for industry level users to monitor a large quantity of UAVs.

In some embodiments, while the mobile terminal 300 uploads the real time video stream of the current UAV to the server 200, if the video stream (including video and audio data) uploading is not smooth due to weak network signals, etc., the mobile terminal 300 can upload only the key frames, video data, etc., so as to solve the video stream uploading problem.

In addition, the method also includes sending the data information of the current UAV to the server 200 for users to obtain the data information of the current UAV through the server 200 to know the real time status of the current UAV. The data information can include status information, livestreaming request, livestreaming confirmation, etc., but not include video stream. In some embodiments, the data information includes the status information of the current UAV. In addition, the status information can include the GPS data (including latitude and longitude) of the current UAV. In addition, the status information can also include the flight height and/or flight speed of the current UAV. In some embodiments, the status information can also include other data information of the current UAV during flight.

FIG. 6 is a flow chart of a method for an interaction between a mobile terminal associated with a UAV and a cloud platform at the server side according to another example embodiment of the disclosure. The method can be implemented in, e.g., the server 200, and the interaction can be between, e.g., the server 200 and the mobile terminal 300. In the embodiment, the interaction between the server 200 and the mobile terminal 300 associated with the UAV is specifically described.

As shown in FIG. 6, at S601, the livestreaming request sent by the mobile terminal 300 associated with the UAV is received. The livestreaming request carries the third address code of the UAV to which the to-be-played live video stream belongs.

The third address code may be used to indicate the UAV information (e.g., UAV identifications, etc.) of a livestreaming requesting UAV (i.e., a UAV waiting to perform livestreaming). Taking the UAV identification as an example of the UAV information for further explanation, after the sever 200 receives the third address code sent by the mobile terminal 300 controlling the current livestreaming requesting UAV, the server 200 can search according to the UAV identification indicated by the third address code to see if there is the storage space for storing the to-be-played live video on the server 200. If the located storage space is enough (the located storage space larger or equal to the preset storage space), the current livestreaming request is successful, and the server 200 generates the fourth address code of the UAV to which the to-be-played live video stream belongs according to the located storage space. If the located storage space is not enough (smaller than the preset storage space), the livestreaming request is not successful, and the server 200 returns the second prompt message to the corresponding mobile terminal 300 indicating the failure of the current livestreaming request. The third address code can be pre-stored in the mobile terminal 300 for controlling the livestreaming requesting UAV.

In addition, the livestreaming request carries the terminal identification of the mobile terminal 300 associated with the livestreaming requesting UAV. After the server 200 receives the livestreaming request, the legitimacy of the mobile terminal 300 is verified. When the server 200 determines the terminal identification carried by the livestreaming request as a legitimate terminal identification, the mobile terminal 300 that is currently sending the livestreaming request is determined as a legitimate terminal and the current livestreaming request is successful. The server 200 sends the second response carrying the fourth address code to the mobile terminal 300. When the server 200 determines the terminal identification carried by the current livestreaming request as an illegal terminal identification, the mobile terminal 300 that is currently sending the livestreaming request is determined as an illegal terminal and the current livestreaming request is unsuccessful. The server 200 sends the second prompt message to the corresponding mobile terminal 300 to indicate the failure of the current livestreaming request. The server 200 determines the mobile terminal 300 that is currently sending the livestreaming request as an illegal terminal and returns the second prompt message rather than the second response, to improve the security of the UAV livestreaming.

The livestreaming confirmation is used to indicate the livestreaming status of the current UAV. In some embodiments, in the preset time (e.g., 10 s) after the server 200 receives the livestreaming request sent from the mobile terminal 300 associated with the UAV, when the real time video stream of the current UAV uploaded by the mobile terminal 300 is received according to the livestreaming address, the server 200 generates a livestreaming confirmation to prompt the cloud platform 100 that the livestreaming request sent by the mobile terminal 300 associated with the current UAV is successful. Thus the user is allowed to obtain the live video stream of the current UAV through the operation of the cloud platform 100 according to demand.

In other embodiments, after the mobile terminal 300 generates the livestreaming address of the UAV to which the to-be-played live video stream belongs, the livestreaming confirmation is sent to the server 200. The server 200 can receive the livestreaming confirmation sent by the mobile terminal 300 associated with the current UAV to prompt the cloud platform 100 that the livestreaming request sent by the mobile terminal 300 associated with the current UAV is successful. The user is allowed to operate the cloud platform 100 to obtain the live video stream of the current UAV according to demand.

At S602, in response to the livestreaming request, the second response is returned to the mobile terminal 300 that sent the livestreaming request to trigger the mobile terminal 300 to obtain the livestreaming address of the current UAV according to the second response and the third address code, and upload the real time video stream to the server 200 that received the livestreaming request according to the livestreaming address, for the cloud platform 100 to obtain the livestreaming address through the server 200 and play the real time video stream of the current UAV.

In some embodiments, after the mobile terminal 300 associated with the UAV obtains the livestreaming address from the server 200, the UAV real time video stream is pushed to the server 200. The cloud platform 100 can pull (display) after obtaining the livestreaming address of the UAV from the server 200 to realize the real time sharing of the UAV video stream and monitor the UAV conveniently. These features are particularly suitable for the industry level users to monitor a large quantity of UAVs.

In some embodiments, returning the second response, by the server 200 in response to the livestreaming request, to the mobile terminal 300 that sent the livestreaming requesting includes searching for the storage space for storing the to-be-played live video according to the third address code. Server 200 then generates the fourth address code of the UAV to which the to-be-played live video stream belongs according to the located storage space. Finally, Server 200 returns the second response containing the fourth address code of the UAV to which the to-be-played live video stream belongs to the mobile terminal 300, for description of which, reference can be made to the description of S601.

In addition, returning by the server 200 the second response containing the fourth address code of the UAV, to which the to-be-played live video stream belongs, to the mobile terminal 300 is executed when the server 200 determines the terminal identification as a legitimate terminal identification. The illegal stealing of the livestreaming address is prevented and the interference with the UAV livestreaming is reduced for a smooth livestreaming of the livestreaming requesting UAV. That is, after the livestreaming request is successful, the mobile terminal 300 associated with the livestreaming requesting UAV can upload the video stream to the server 200 smoothly.

In addition, the second response carries the second time threshold. The second time threshold is used to indicate that the fourth address code is valid when the time since the server 200 sent the fourth address code is less than or equal to the second time threshold, and the fourth address code is invalid when the time since the server 200 sent the fourth address code is longer than the second time threshold. In this way, even if both the third and fourth address codes are illegally stolen by the illegal mobile terminal 300 at the same time such that the current mobile terminal 300 cannot upload the video stream of the current livestreaming requesting UAV to the server 200, since the fourth address code is effective for a given period of time, only temporary interference can be caused to the current mobile terminal 300. By setting the fourth address code being effective for a given period of time, the security of the UAV livestreaming is increased significantly. For example, the second preset time threshold can be set to 10 minutes, the illegal mobile terminal 300 illegally stealing the livestreaming address can interfere for 10 minutes at maximum. After 10 minutes, the server 200 generates a new fourth address code and sends the new fourth address code to the livestreaming request sending mobile terminal 300. The difficulty of illegal stealing of the complete livestreaming address code is increased and the security of the UAV livestreaming is improved. After the server 200 generates the fourth address code of the UAV to which the to-be-played live video stream belongs according to the located storage space, if the server 200 determines the terminal identification as an illegal terminal identification, the execution of the operation to return the second response containing the fourth address code of the UAV, to which the to-be-played live video stream belongs, to the mobile terminal 300 is canceled, which prevents the illegal stealing of the livestreaming address of the current UAV. In some embodiments, when the server 200 determines the terminal identification as an illegal terminal identification, the server 200 returns the second prompt message indicating the failure of the livestreaming request to the livestreaming request sending mobile terminal 300 according to the livestreaming request to prompt the user the failure of the livestreaming request for the livestreaming requesting UAV.

In addition, the method also includes receiving the data information of the current UAV sent by the mobile terminal 300 associated with the current UAV and sending the received data information to the cloud platform 100 for users to obtain the data information of the current UAV to be aware of the real time status of the current UAV in time. The data information can include status information, livestreaming request, livestreaming confirmation, etc., but does not include video stream. In some embodiments, the data information includes the status information of the current UAV. In addition, the status information can include GPS data (including latitude and longitude) of the current UAV. In addition, the status information can also include flight height and/or flight speed of the current UAV. In some embodiments, the status information can also include other data information of the current UAV during flight.

The interaction method for the mobile terminal associated with the UAV and the cloud platform shown in FIG. 6 can be further explained with reference to the interaction method for the mobile terminal associated with the UAV and the cloud platform shown in FIG. 5.

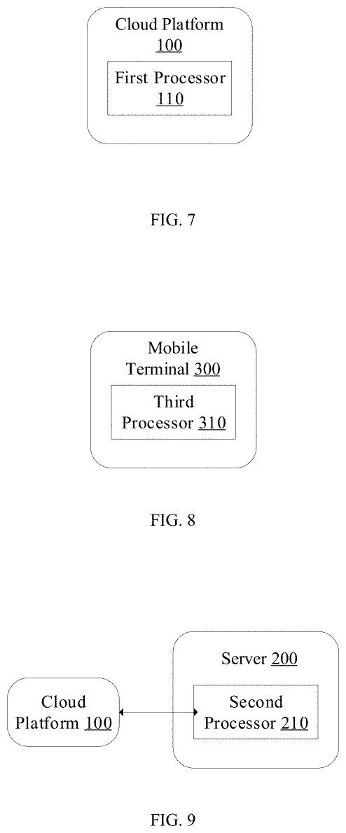

FIG. 7 is a schematic structural diagram of a device for an interaction between a mobile terminal associated with a UAV and a cloud platform at the platform side according to an example embodiment of the disclosure.

In conjunction with FIGS. 7 and 11, the interaction device for the mobile terminal associated with the UAV and the cloud platform includes a first processor 110 (e.g., a single core or multi-core processor). In some embodiments, one or more first processors 110 can be provided, which can, individually or collectively, execute the operations of the interaction method for the mobile terminal and the cloud platform associated with the UAV in the embodiment above.

The first processor 110 and the server 200 are communicatively connected to realize the data interaction.

FIG. 8 is a schematic structural diagram of a device for an interaction between a mobile terminal associated with a UAV and a cloud platform at the terminal side according to an example embodiment of the disclosure.

In conjunction with FIGS. 8 and 11, the interaction device for the mobile terminal associated with the UAV and the cloud platform includes a third processor 310 (e.g., a single core or multi-core processor). In some embodiments, one or more third processors 310 can be provided, which can, individually or collectively, execute the operations of the interaction method for the mobile terminal associated with the UAV and the cloud platform in the embodiment above.

The third processor 310 and the server 200 are communicatively connected to realize the data interaction.

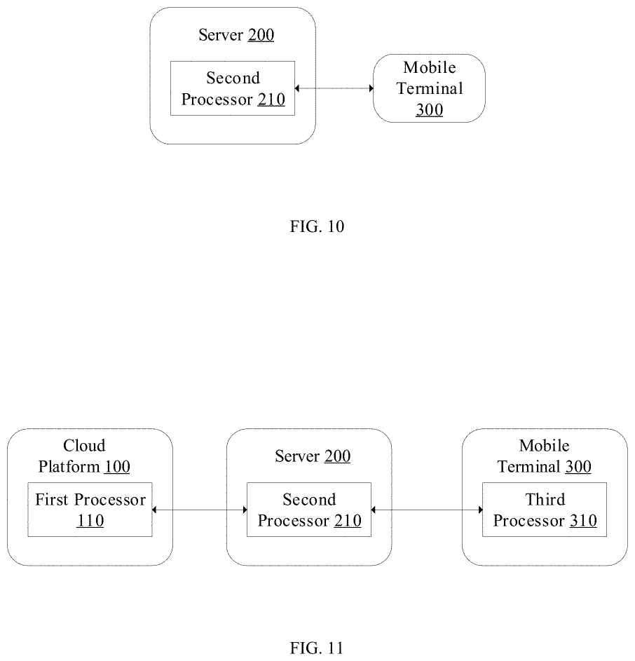

FIGS. 9 and 10 are schematic structural diagrams of devices for an interaction between a mobile terminal associated with a UAV and a cloud platform at the server 200 side according to the embodiment of the disclosure.

In conjunction with FIGS. 9, 10, and 11, the interaction device for the mobile terminal associated with the UAV and the cloud platform includes a second processor 210 (e.g., a single core or multi-core processor). In some embodiments, one or more second processors 210 can be provided, which can, individually or collectively, execute the operations of the interaction method for the mobile terminal associated with the UAV and the cloud platform in the embodiment above.

The second processor 210 is communicatively connected with the cloud platform 100 and the mobile terminal 300 for controlling the UAV to realize data interaction. When the second processor 210 performs data interaction with the cloud platform 100, the second processor 210 executes the operations of the interaction method for the mobile terminal associated with the UAV and the cloud platform, such as the method described above in connection with FIG. 4. When the second processor 210 performs the data interaction with the mobile terminal 300 for controlling the UAV, the second processor 210 executes the operations of the interaction method for the mobile terminal associated with the UAV and the cloud platform, such as the method described above in connection with FIG. 6.

In the embodiments of the present disclosure, there is provided a computer storage medium, and the computer storage medium stores program commands. The program executes the interaction method for the mobile terminal associated with the UAV and the cloud platform in the embodiments above.

Since the device embodiments correspond to the method embodiments, for the description of functions of various parts of the devices, reference can be made to the description above of corresponding parts of the method embodiments. The device embodiments described above are merely illustrative, where the units described as separate components may or may not be physically separated, and the component shown as a unit may or may not be a physical unit, which may be located in one place or distributed to multiple network units. The solution of the embodiment can be implemented by some or all the units according to actual needs. One of ordinary skill in the art can understand and implement the embodiments without creative effort.

The phrases like “specific embodiments” or “some embodiments” may refer to at least one embodiment or example of the present disclosure containing the specific features, structures, materials, or characteristics. In the present specification, the illustrative descriptions of the above terms do not necessarily refer to the same embodiment or example. In addition, the specific features, structures, materials, or characteristics described may be combined appropriately in any one or more embodiments or examples.

Any process or method described in the flowchart or in other forms herein can be represented as a unit, segment or portion of executable command codes that include one or more operations to implement a particular logical function or process. The scope of the embodiments of the disclosure can include additional implementations not following the order in the described or discussed embodiments, including executing the functions simultaneously or in the reverse order according to the involved functions, which can be understood by those skilled in the art.

The logical functions and/or operations shown in the flowchart or described in other forms, for example, can be considered as an ordered list of executable commands to implement logical functions, which may be implemented in any computer readable medium for a command execution system, an apparatus, or a device (e.g., a computer based system, a system including processor or other system that can read and execute commands from the command execution system, apparatus, or device), or implemented in combination with these command execution system, apparatus, or device. For the present specification, “computer readable medium” can be any device which can contain, store, communicate, propagate or transfer programs for the command execution system, apparatus, or device, or an apparatus in conjunction with the command execution system, apparatus, or device. The computer readable medium can include (non-exhaustive) an electrical connection (electronic device) with one or more wirings, a portable computer case (magnetic device), a random access memory (RAM), a read only memory (ROM), an erasable and programmable read-only memory (EPROM or flash memory), an optic fiber device, and a portable compact disk read-only memory (CDROM). In addition, the computer readable medium can even be papers or other appropriate medium on which the programs can be printed, because optical scan can be implemented for the paper or the other medium, then the program can be obtained digitally by editing, decoding or other appropriate methods, and then the program can be stored in a computer storage device.

In the disclosure, the individual parts can be implemented by hardware, software, firmware or a combination thereof. In the embodiments above, multiple operations or methods may be implemented by software or firmware stored in the memory and executed by the appropriate execution system. For example, if the hardware is used for implementation, as in the other embodiment, one or combinations of the following technologies can be used for implementation: discrete logic circuit of the logic gate circuit to implement logic functions on data signals, application-specific integrated circuit (ASIC) with appropriate combinational logic gate, programmable gate array (PGA), field programmable gate array (FPGA), etc.

One of ordinary skill in the art can understand that all or part of the operations of the implementation methods above can be executed by instructing the corresponding hardware with the program, which can be stored in a computer readable storage medium. When the program is executed, one or combination of the operations in the method embodiments is performed.

In addition, individual functional units in each embodiment of the present disclosure can be integrated into one processing circuit or can physically separate units, or two or more units are integrated into one unit. The above integrated unit can be implemented by hardware, or by software functional units. If the above integrated unit is implemented by software functional units and sold or used as individual products, it can be also stored in a computer readable medium.

The storage medium mentioned above can be read only memory, disc, or CD, etc. Although some embodiments of the present disclosure have been shown and described above, the above embodiments are illustrative and not considered as a restriction to the disclosure. One of ordinary skill in the art can change, modify, substitute, and vary the above-mentioned embodiments in the scope of the disclosure.

What is claimed is:

1. An interaction method comprising:
obtaining a livestreaming confirmation from a server, the livestreaming confirmation indicating that an unmanned aerial vehicle (UAV) is in a livestreaming status;
obtaining a livestreaming address corresponding to the UAV from the server; and
playing, according to the livestreaming address, a real time video stream uploaded by a mobile terminal associated with the UAV to the server.

2. The method of claim 1, wherein obtaining the livestreaming address from the server includes:
sending a streaming request to the server;
receiving a response returned by the server in response to the streaming request; and
obtaining the livestreaming address according to the response.

3. The method of claim 2, wherein:
the streaming request carries an address code of the UAV; and
obtaining the livestreaming address includes obtaining the livestreaming address according to the response and the address code.

4. The method of claim 3, wherein obtaining the livestreaming address includes obtaining the livestreaming address according to the response and the address code in response to determining that the response satisfies a condition.

5. The method of claim 4, wherein:
the address code is a first address code; and
determining that the response satisfies the condition includes determining that the response includes a second address code of the UAV.

6. The method of claim 5, wherein determining that the response satisfies the condition further includes determining that a time since the server sent the second address code is shorter than or equal to a time threshold.

7. The method of claim 5, wherein obtaining the livestreaming address includes generating the livestreaming address according to the first address code and the second address code.

8. The method of claim 7, wherein generating the livestreaming address according to the first address code and the second address code includes combining the first address code and the second address code to generate the livestreaming address.

9. The method of claim 5, further comprising, after determining that the response carries the second address code:
canceling an operation to obtain the livestreaming address in response to determining that a time since the server sent the second address code is longer than a time threshold.

10. The method of claim 9, further comprising, after determining that the time since the server sent the second address code is longer than the time threshold:
generating a prompt message to indicate a failure of the streaming request.

11. The method of claim 2, wherein the streaming request carries a user identification.

12. An interaction device comprising:
one or more processors individually or collectively configured to:
obtain a livestreaming confirmation from a server, the livestreaming confirmation indicating that an unmanned aerial vehicle (UAV) is in a livestreaming status;
obtain a livestreaming address corresponding to the UAV from the server; and
play, according to the livestreaming address, a real time video stream uploaded by a mobile terminal associated with the UAV to the server.

13. The device of claim 12, wherein the one or more processors are further configured to:
send a streaming request to the server;
receive a response returned by the server in response to the streaming request; and
obtain the livestreaming address according to the response.

14. The device of claim 13, wherein:
the streaming request carries an address code of the UAV; and
the one or more processors are further configured to obtain the livestreaming address according to the response and the address code.

15. The device of claim 14, wherein the one or more processors are further configured to obtain the livestreaming address according to the response and the address code in response to determining that the response satisfies a condition.

16. The device of claim 15, wherein:
the address code is a first address code; and
the one or more processors are further configured to determine that the response includes a second address code of the UAV.

17. The device of claim 16, wherein the one or more processors are further configured to determine that a time since the server sent the second address code is shorter than or equal to a time threshold.

18. The device of claim 16, wherein the one or more processors are further configured to generate the livestreaming address according to the first address code and the second address code.

19. An interaction method compromising:
receiving, by a server, a streaming request from a cloud platform, the streaming request carrying an address code associated with an unmanned aerial vehicle (UAV) to which a to-be-played live video stream belongs; and
returning a response to the cloud platform in response to the streaming request to trigger the cloud platform to obtain a livestreaming address corresponding to the UAV according to the response and the address code, and play, according to the livestreaming address, a real time video stream uploaded by a mobile terminal associated with the UAV to the server.
